(19) United States
(12) Patent Application Publication
(10) Pub. No.: US 2005/0097185 A1
(43) Pub. Date: May 5, 2005

(54) Localization link system

(76) Inventors: Simon Gibson, Washington, DC (US); Thomas Pepper, Boulder Creek, CA (US)

Correspondence Address: GLENN PATENT GROUP, 3475 EDISON WAY, SUITE L, MENLO PARK, CA, 94025, US

(21) Appl. No.: 10/681,051

(22) Filed: Oct. 7, 2003

(51) Int. Cl. G06F 15/16

(52) U.S. Cl. 709/217; 709/218; 709/219; 709/223

(57) ABSTRACT

A method is provided which directs users to the closest mirror site for desired content. For each mirrored instance of a content store, the distance is determined to each of the networks from which users connect, wherein the determined distance is typically based upon the number of hops and or latency. The localization information is stored, such as by populating a localization database or a localization web service. Upon receipt of a user request for a web page that includes a link to localized/mirrored content, the stored localization information is queried, to determine the closest mirror to the user, based upon the IP address of the user terminal or network. A web page is then generated and transmitted to the user, which comprises a localized link to the determined mirror site. When the user selects the localized link, the user is automatically directed to the closest, i.e. local, mirror.

### FIELD OF THE INVENTION

The invention relates to the localization of information in a network environment. More particularly, the invention relates to the determination of localization information in a network environment and the creation of a localized link to the information.

### BACKGROUND OF THE INVENTION

The Internet comprises a web of computers and networks, which are widely spread throughout the world. The Internet currently comprises millions of network connections, and is used by millions of people, such as for business, education, entertainment, and/or basic communication. Each terminal, e.g. client computer, router, sever, or node, that is connected to the Internet has a unique Internet address. A message can be sent from any computer to any other computer across the Internet, through the specification of a destination address, and the transport of the message from computer to computer, through a series of “hops”. When an intermediate computer or router receives a message in transit, the intermediate computer checks the intended destination of the message and passes it along.

The time to send information between a sender, e.g. a content provider, and a receiver is dependent on the number of hops, as well as the latency of the transmission. Latency comprises the time for a packet to cross each network connection, as well as any time that a packet frame is held by in intermediate device, before the packet is forwarded toward the receiver.

Mirroring is a process that duplicates information from one location to another. Content providers often mirror content to other servers, i.e. mirror sites, across the world, to bring content closer to recipients, and to reduce the overall latency and number of router hops that data must travel to get to a recipient.

Content distribution is a managed form of mirroring, in which copies of content are located at caching servers at ISP sites and Internet data centers, by companies such as Akamai. In a distributed content environment, as a user accesses a web site, the desired content may be cached in a local content distribution server, such that the time to access content is reduced.

At the present time, some companies, such as Akamai, Inc., offer services whereby web sites are able to distribute servers across the world. If access to a web site is congested, such services help to route the user to an alternate mirror site that has the same content.

While some technologies determine proximity through BGP, Traceroute, and/or Ping methodologies, such localization is typically based on either a DNS connection, or on dial-up links. For example, in some systems, such as available through Nortel, Inc., localization is based upon the location of a routing computer through which a telephone line connected to the Internet.

Several structures and methods have been described for the storage and retrieval of data in a network environment.

J. Brendel, C. Kring, Z. Liu, and C. Marino, World-Wide-Web Server with Delayed Resource-Binding for Resource-based Load Balancing on a Distributed Resource Multi-Node Network, U.S. Pat. No. 5,774,660, describe a multi-node server, which transmits world-wide-web pages to network-based browser clients. A load balancer receives all requests from clients because they use a virtual address for the entire site. The load balancer makes a connection with the client and waits for the URL from the client. The URL specifies the requested resource. The load balancer waits to perform load balancing until after the location of the requested resource is known. The connection and URL request are passed from the load balancer to a second node having the requested resource. The load balancer re-plays the initial connection packet sequence to the second node, but modifies the address to that for the second node. The network software is modified to generate the physical network address of the second node, but then changes the destination address back to the virtual address. The second node transmits the requested resource directly to the client, with the virtual address as its source. Since all requests are first received by the load balancer which determines the physical location of the requested resource, nodes may contain different resources. The entire contents of the web site is not mirrored onto all nodes. Network bottlenecks are avoided since the nodes transmit the large files back to the client directly, bypassing the load balancer. Client browsers can cache the virtual address, even though different nodes with different physical addresses service requests.”

B. Kenner and A. Karush, System and Method for Optimized Storage and Retrieval of Data on a Distributed Computer Network, U.S. Pat. No. 6,003,030, describe “A system and method for the optimized storage and retrieval of video data at distributed sites calls for the deployment of “Smart Mirror” sites throughout a network, each of which maintains a copy of certain data managed by the system. Every user is assigned to a specific delivery site based on an analysis of network performance with respect to each of the available delivery sites. Generalized network performance data is collected and stored to facilitate the selection of additional delivery sites and to ensure the preservation of improved performance in comparison to traditional networks.”

F. Leighton and D. Lewin, Global Hosting System, U.S. Pat. No. 6,108,703, describe a network architecture or framework which “supports hosting and content distribution on a truly global scale. The inventive framework allows a Content Provider to replicate and serve its most popular content at an unlimited number of points throughout the world. The inventive framework comprises a set of servers operating in a distributed manner. The actual content to be served is preferably supported on a set of hosting servers (sometimes referred to as ghost servers). This content comprises HTML page objects that, conventionally, are served from a Content Provider site. In accordance with the invention, however, a base HTML document portion of a Web page is served from the Content Provider's site while one or more embedded objects for the page are served from the hosting servers, preferably, those hosting servers near the client machine. By serving the base HTML document from the Content Provider's site, the Content Provider maintains control over the content.”

B. Kenner, K. Colby, and R. Mudry, System and Method for Server-Side Optimization of Data Delivery on a Distributed Computer Network, U.S. Pat. No. 6,112,239, describe “A system and method for the optimized storage and retrieval of video data at distributed sites calls for the deployment of “Smart Mirror” sites throughout a network, each of which maintains a copy of certain data managed by the system. User addresses are assigned to specific delivery sites based on an analysis of network performance with respect to each of the available delivery sites. Generalized network performance data is collected and stored to facilitate the selection of additional delivery sites and to ensure the preservation of improved performance in comparison to traditional networks.”

B. Kenner and A Karush, System and Method for Optimized Storage and Retrieval of Data on a Distributed Computer Network, U.S. Pat. No. 6,154,744, describe “A system and method for the optimized storage and retrieval of video data at distributed sites calls for the deployment of “Smart Mirror” sites throughout a network, each of which maintains a copy of certain data managed by the system. Every user is assigned to a specific delivery site based on an analysis of network performance with respect to each of the available delivery sites. Generalized network performance data is collected and stored to facilitate the selection of additional delivery sites and to ensure the preservation of improved performance in comparison to traditional networks.”

J. Brendel, Client-Side Resource-Based Load-Balancing with Delayed-Resource-Binding Using TCP State Migration to WWW Server Farm, U.S. Pat. No. 6,182,139, describes “A client-side dispatcher resides on a client machine below high-level client applications and TCP/IP layers. The client-side dispatcher performs TCP state migration to relocate the client-server TCP connection to a new server by storing packets locally and later altering them before transmission. The client-side dispatcher operates in several modes. In an error-recovery mode, when a server fails, error packets from the server are intercepted by the client-side dispatcher. Stored connection packet's destination addresses are changed to an address of a relocated server. The altered packets then establish a connection with the relocated server. Source addresses of packets from the server are changed to that of the original server that crashed so that the client application is not aware of the error. In a delayed URL-based dispatch mode, the client-side dispatcher intercepts connection packets before they are sent over the network. Reply packets are faked by the client-side dispatcher to appear to be from a server and then sent to up to the client TCP/IP layers. The client's TCP then sends URL packet identifying the resource requested. The client-side dispatcher decodes the URL and picks a server and sends the packet to the server. Reply packets from the server are intercepted, and data packets altered to have the source address of the faked server. Multicast of the initial packet to multiple servers is used for empirical load-balancing by the client. The first server to respond is chosen while the others are reset. Thus the client-side dispatcher picks the fastest of several servers.”

D. Farber, R. Greer, A. Swart, and J. Balter, Optimized Network Resource Location, U.S. Pat. No. 6,185,598, describe “Resource requests made by clients of origin servers in a network are intercepted by reflector mechanisms and selectively reflected to other servers called repeaters. The reflectors select a best repeater from a set of possible repeaters and redirect the client to the selected best repeater. The client then makes the request of the selected best repeater. The resource is possibly rewritten to replace at least some of the resource identifiers contained therein with modified resource identifiers designating the repeater instead of the origin server.”

B. Kenner and A. Karush, System and Method for Optimized Storage and Retrieval of Data on a Distributed Computer Network, U.S. Pat. No. 6,502,125, describe “A system and method for the optimized storage and retrieval of video data at distributed sites calls for the deployment of “Smart Mirror” sites throughout a network, each of which maintains a copy of certain data managed by the system. Every user is assigned to a specific delivery site based on an analysis of network performance with respect to each of the available delivery sites. Generalized network performance data is collected and stored to facilitate the selection of additional delivery sites and to ensure the preservation of improved performance in comparison to traditional networks.”

Other structures and methods have also been described for the storage, mirroring, caching, and/or retrieval of data in a network environment, such as: Optimized Network Resource Location, European Patent Application Number EP 1143337; A. Chankhunthod, P. Danzig, C. Neerdaels, M. Schwartz, and K. Worrell, A Hierarchical Internet Object Cache, Technical Report CU-CS-766-95, March 1995; J. Gwertzman, Autonomous Replication in Wide-Area Internetworks, Center for Research in Computing Technology Harvard University; April 1995; J. Gwertzman and M. Seltzer, The Case for Geographical Push-Caching; Division of Applied Sciences Harvard University; and A. Whitcroft, N. Williams, and P. Osmon, The Wide Area Data Space; Systems Architecture Research Centre City University.

Other systems provide various details of information management and access in a network environment, such as D. Haller, T. Nguyen, K. Rowney, D. Berger, and G. Kramer, System, Method and Article of Manufacture for Managing Transactions in a High Availability System, U.S. Pat. No. 6,026,379; N. Feldmen, A. Viswanathan, R. Woundy, and R. Boivie, Mapping of Routing Traffic to Switching Networks, U.S. Pat. No. 6,055,561; T. Win and E. Belmonte, Administrative Roles that Govern Access to Administrative Functions, U.S. Pat. No. 6,161,139; M. Himmel, Customization of Web Pages Based on Requester Type, U.S. Pat. No. 6,167,441; A. De Boor and M. Eggers, Wireless Communication Device with Markup Language Based Man-Machine Interface, U.S. Pat. No. 6,173,316; T. Win and E. Belmonte, Distributed Access Management of Information Resources, U.S. Pat. No. 6,182,142; M. Himmel, H. Rodriguez, and J. LaBaw, Searching and Serving Bookmark Sets Based on Client Specific Information, U.S. Pat. No. 6,314,423; M. Himmel, H. Rodriguez, and J. LaBaw, Internet Advertising Via Bookmark Set Based on Client Specific Information, U.S. Pat. No. 6,324,566; M. Bowman-Amuah, Method for Providing Communication Services Over a Computer Network System, U.S. Pat. No. 6,332,163; W. Barker, L. Connelly, M. Eggert, M. Foley, K. Macfarlane, P. Parsons, G. Rai, J. Rog, and K. Vangsness, Method for Computer Internet Remote Management of a Telecommunication Network Element, U.S. Pat. No. 6,363,421; M. Medin Jr., System and Method for Delivering High-Performance Online Multimedia Services, U.S. Pat. No. 6,370,571; D. Schneider, M. Ribet, L. Lipstone, and D. Jensen, Distributed Administration of Access to Information, U.S. Pat. No. 6,408,336; M. Bowman-Amuah, Delivering Service to a Client Via a Locally Addressable Interface, U.S. Pat. No. 6,438,594; A. De Boor and M. Eggers, Wireless Communication Device with Markup Language Based Man-Machine Interface, U.S. Pat. No. 6,470,381; C. Combar, C. Devine, and R. Pfister, Integrated Interface for Real Time Web Based Viewing of Telecommunications Network Call Traffic, U.S. Pat. No. 6,515,968; G. Tripp, M. Meadway, and C. Duguay, Sending to a Central Indexing Site Meta Data or Signatures from Objects on a Computer Network, U.S. Pat. No. 6,516,337; Place-Specific Buddy List Services, European Patent Application Number EP 1176840; Routing Method Using a Genetic Algorithm, European Patent Application Number EP 921661; M. Sinnwell and G. Weikum, A Cost-Model-Based Online Method for Distributed Caching, Department of Computer Science, University of the Saarland; A. Baggio, System Support for Transparency and Network-aware Adaptation in Mobile Environments, Project SOR INRIA; A. Chankhunthod, P. Danzig, C. Neerdaels, M. Schwartz, and K. Worrell, A Hierarchical Internet Object Cache, Computer Science Department, University of Southern California; E. Kawai, K. Osuga, K. Chinen, and S. Yamaguchi, Duplicated Hash Routing: A Robust Algorithm for a Distributed WWW Cache System; Graduate School of Information Science, Nara Institute of Science and Technology; K. Karlapalem, Q. Li, and C. Shum, HODFA: An Architectural Framework for Homogenizing Heterogeneous Legacy Databases; Department of Computer Science, Hong Kong University of Science and Technology, 1994; G. Goldzmidt, and A. Stanford-Clark, Load Distribution for Scalable Web Services: Summer Olympics 1996—A Case Study, IBM Watson Research Center; and M. Rabinovich, J. Chase, and Syam Gadde, Not all Hits Are Created Equal: Cooperative Proxy Caching Over a Wide-Area Network, AT&T Labs, Department of Computer Science, Duke University.

While some technologies describe localization structures and methods for the storage, mirroring, caching, and/or retrieval of data in a network, such localization is typically based on either a DNS connection, or on dial-up links.

It would be advantageous to provide a system and an associated method which directs a user to a preferred mirror, based upon the IP address of the user terminal. The development of such an information access system would constitute a major technological advance.

It would be advantageous to provide a localization of http links, in which a user terminal is able to link to desired content from a localized mirror site, i.e., from which the number of hops and/or latency is minimized. The development of such an information access system would constitute a major technological advance.

Furthermore, it would be advantageous to provide a localization of http links, which allows a user to navigate to a preferred mirror site, in which the overall cost is minimized. The development of such a system and an associated method would constitute a further technological advance.

As well, it would be advantageous that such a link localization system be integrated with existing network structures, such that the link localization system is readily used by a wide variety of sites. The development of such a link localization system would constitute a further major technological advance.

### SUMMARY OF THE INVENTION

A method is provided which directs users to a preferred mirror site for desired content. For each mirrored instance of a content store, the distance is determined to each of the networks from which users connect, wherein the determined distance is typically based upon the number of hops and or latency. The localization information is stored, such as by populating a localization database or a localization web service. Upon receipt of a user request, such as within a web page, that includes a link to localized/mirrored content, the stored localization information is queried, to determine the preferred mirror to the user, based upon the IP address of the user terminal or network. A web page is then generated and transmitted to the user, which comprises a localized link to the determined mirror site. When the user selects the localized link, the user is automatically directed to the preferred mirror.

### BRIEF DESCRIPTION OF THE DRAWINGS

FIG. 1 is a schematic view of a network established between a content provider, one or more mirror sites, and one or more user terminals;

FIG. 2 is a flowchart of a process for the localization of http links;

FIG. 3 shows the determination of hops and latency for information sent from a plurality of mirror sites to an endpoint;

FIG. 4 is a schematic view of stored localization information; and

FIG. 5 is a schematic view of an IP proximity resource allocation system.

### DETAILED DESCRIPTION OF PREFERRED EMBODIMENTS

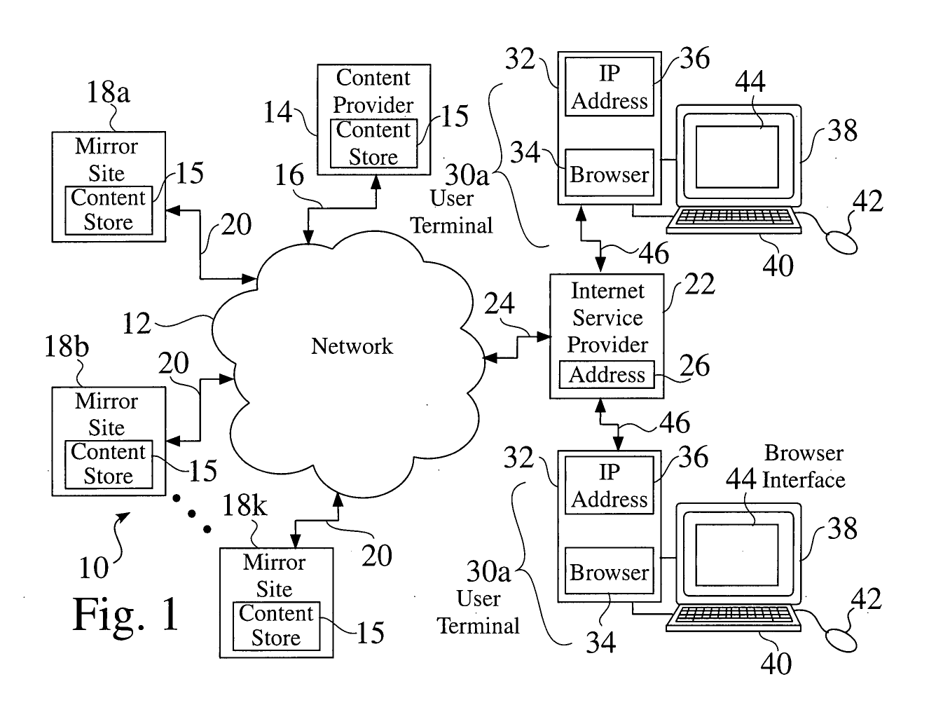

FIG. 1 is a schematic view 10 of a network structure 10 established between a content provider 14, one or more mirror sites 18a-18k, and one or more user terminals 30a,30b. A service provider 22, e.g. an Internet service provider 22, having a provider address 26, is connected to the network 12, such as the Internet 12. User terminals 30, e.g. 30a,30b, are typically connected 46 to the network 12 through the service provider 22.

The exemplary user terminals 30 shown in FIG. 1 typically comprise personal computers, mobile devices, and other microprocessor-based devices, such as portable digital assistants or network enabled cell phones.

The exemplary user terminals 30a,30b shown in FIG. 1 comprise a processor 32, a display 38, and a user interface, such as a keyboard 40 and a mouse 42. The user terminals 30a,30b shown in FIG. 1 also comprise a browser application 34, which includes a browser interface 44, through which a user can interact with the network 12. A unique IP address is also associated with each of the user terminals 32.

As seen in FIG. 1, an exemplary content provider 14 is connected 16 to the network 12, which provide stored content 15 that is accessible to one or more user terminals 30. The content store 15 is often duplicated and stored within the content store 15 of one or more mirror sites 18a-18k, to increase the speed and capacity to distribute the information 15 to a large number of user terminals 30.

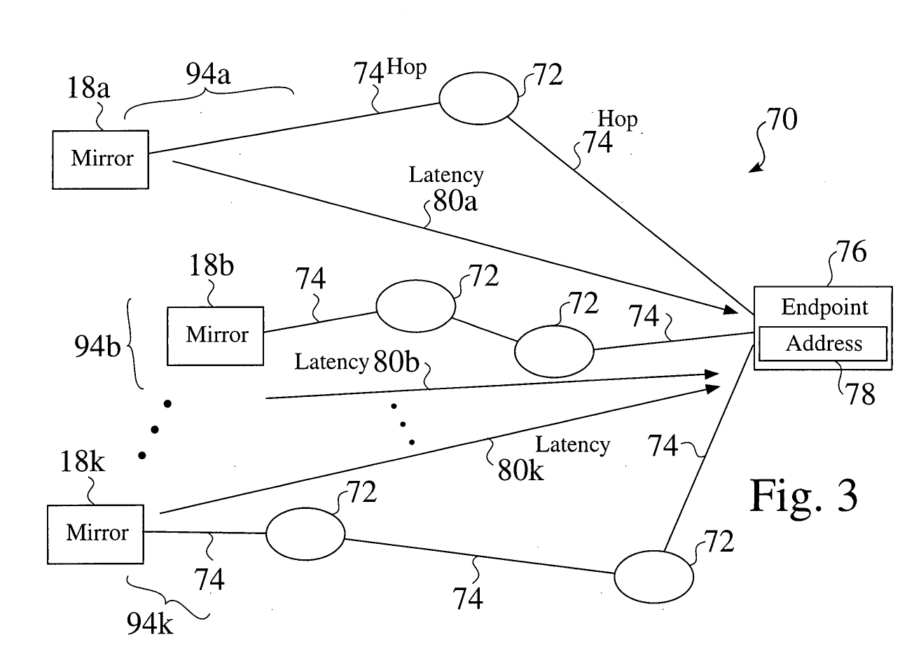

Network intensive content 15, such as video or audio streams, are often times mirrored at multiple locations 18a-18k, on the Internet or on an internal network, such as AOL. The connection distance, i.e. number of hops 74 (FIG. 3), or latency 80 (FIG. 3) for some mirrors 18 may be greater than for other mirrors 18 of the same content 15.

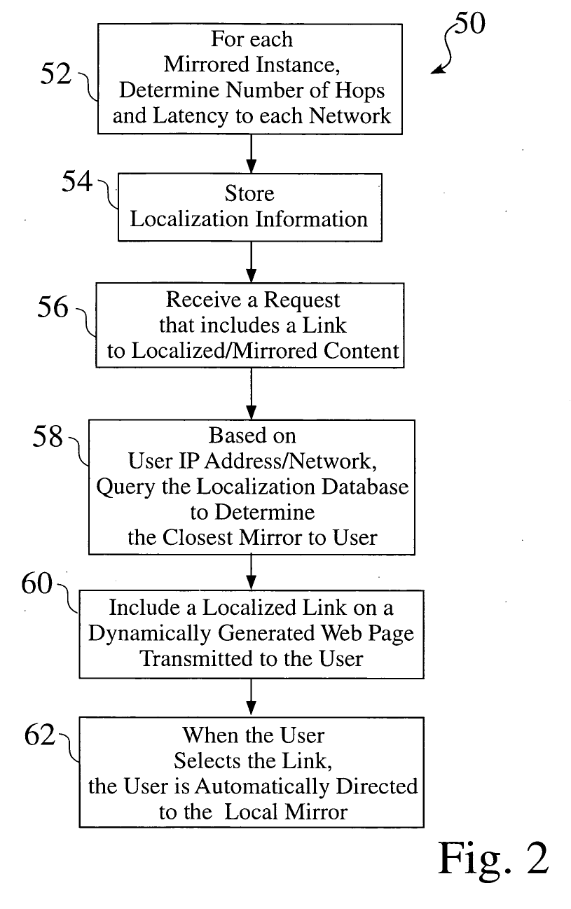

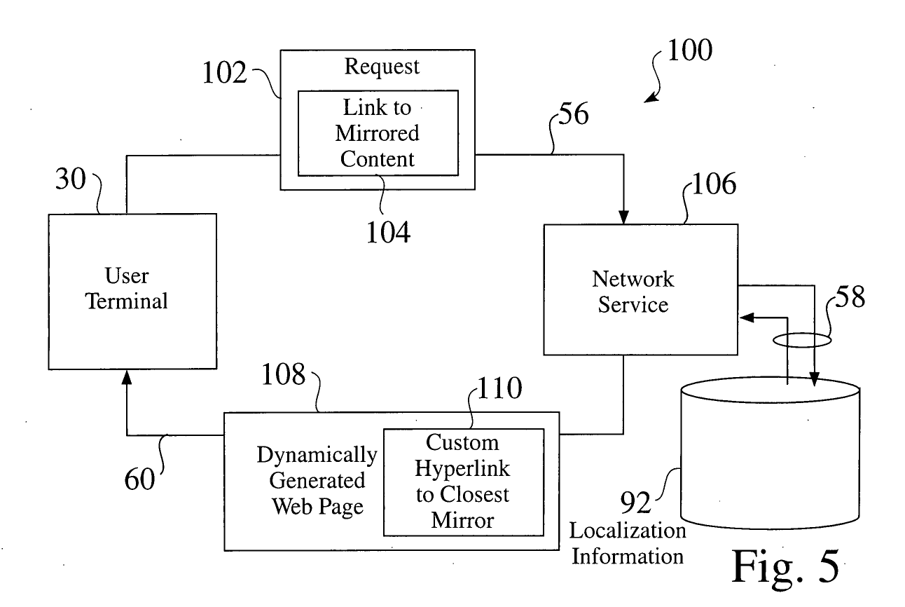

In many cases, content is not mirrored and it is delivered to the user from the same location, regardless of the distance between the user and the content store. By mirroring the content stores, the content is brought closer to the user. The localization link system 100 (FIG. 5) and process 50 (FIG. 2) provides a method for directing users automatically to the closest mirror 18.

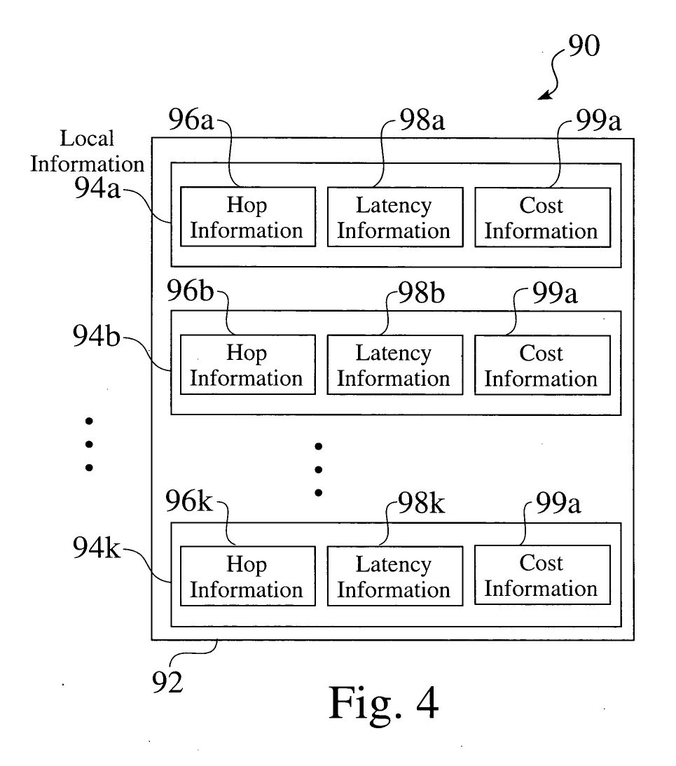

FIG. 2 is a flowchart of a process 50 for the localization of http links. At a localization determination step 52, for each mirrored instance 18, i.e. each mirror site 18 having a duplicate content store 15, localization information 94, e.g. 94a-94k (FIG. 4) is determined to each network 12,22. The localization information 94 typically comprises the number of hops 74 (FIG. 3) and latency 80, e.g. 80a-80k (FIG. 3).

When a request 102 is made that includes a link to localized, i.e. mirrored content 15, at step 56, the localization information 54 is queried 58, to determine the preferred, i.e. closest, mirror site 18 to the user terminal 30, based upon either the user IP address 36 (FIG. 1) or the network IP address 26 (FIG. 1).

A web page 108 (FIG. 5) is then generated 60, which includes a localized link 110, such that a user may selectably access the mirrored content 15 from the preferred mirror site 18 through the user terminal 30. When a user selects the link 62, the user terminal 30 is automatically directed to the local mirror 18.

FIG. 3 shows the determination of localization information 94a-94k, comprising hops 74 and latency 80, e.g. 80a-80k, for information sent from a plurality of mirror sites 18a-18k to an endpoint 76 having a unique address 78, such as to a user terminal 30 having an IP address 36 (FIG. 1), or to a service provider 22 having an address 26 (FIG. 1).

As seen in FIG. 3, the localization information 94a between a first mirror site 18a and an endpoint 76 comprises a two hops 74, through one intermediate node 72, e.g. such as through a router, computer, or other connection 72. The localization information 94a between a first mirror site 18a and an endpoint 76 also comprises a determined latency 80a.

Similarly, the localization information 94b between a second mirror site 18b and the endpoint 76 comprises three hops 74, through two intermediate nodes 72, and a determined latency 80b. As well, the localization information 94k between a third mirror site 18k and the endpoint 76 comprises a three hops 74, through two intermediate nodes 72, and a determined latency 80k.

FIG. 4 is a schematic view 90 of stored localization information 94a-94k, such as within a localization database 92 or localization web service 92. As seen in FIG. 4, the localization information fields 94, e.g. 94a, typically comprise hop information 96, e.g. 96a, and latency information 98, e.g. 98a, and may additionally comprise other relevant localization information 99, e.g. 99a, such as cost information, whereby a preferred mirror site 18 may be determined.

FIG. 5 is a schematic view of an IP proximity resource allocation system 100, which provides localization links 110, such as in accordance with the localization process 50 shown in FIG. 2. As seen in FIG. 5, a request 102 is sent from a user terminal 30, having an associated IP address 36, to a network service 106, such as a web service 106. While the network service 106 may be located at a service provider 22 (FIG. 1), the network service 106 may alternately be located at other locations within the network environment 10. The request 102 includes a mirrored content link 194. Upon receipt of the request 102 and link 104, the local information 92 is queried 58, to determine the preferred mirror site 18.

In one embodiment, a query 58 is run on the localization database 92, which includes set of localization data 94a-94k, comprising the number of hops 74 and measured latency 80 between each mirror 18 and the user's network 22. A set of rules is then run on the resulting data 94a-94k, to select the best mirror 18.

The preferred mirror site 18 in some system embodiments 100 and process embodiments 50 comprises the closest mirror site 18, as a function of hop information 96 and or latency information 98. For example, in some system embodiments 50 the preferred mirror 58 comprises with the mirror 18 comprising the lowest number of hops 74, and in the case of a tie, e.g. two hops 74, the preferred mirror 58 additionally comprises with the mirror 18 having the lowest latency 98.

Other factors 99 can also be measured and taken into account, such as, but not limited to mirror server load, whether a particular mirror is “up”, or the cost of sending traffic along a particular network segment, i.e. some segments are internally owned, and some carriers cost more than other carriers. Therefore, in some system embodiments 100, the localization database 92 further comprises the results of a “cost” function 99, comprising a cost of sending data between each content store-network combination 18,22. The cost function can take into account any and all of the factors mentioned above.

In some system embodiments 100 and process embodiments 50, the preferred mirror site 18 is pre-determined, such that the determination 58 of the preferred mirror 18 is performed as the database 92 is populated 54. For example the desired proximity and cost rules may preferably determined and built into the database 92, such that the preferred mirror 18 is known before a request 102 is received, and such that a web page 108 and localized link 110 may be readily transmitted to the user terminal 30.

System Advantages. The IP proximity resource allocation system 100 and method for localization of http links 50 provide significant advantages over existing content mirroring and localization systems, since localization in the system 100,50 is based upon the actual client IP address 36, rather than to a secondary location, such as to a DNS server to which a client terminal points.

The IP proximity resource allocation system 100 and method for localization of http links 50 determine which of multiple mirror sites are closest to a computer network, based upon an IP address 36. The system 100,50 provides hypertext links 110 for a user terminal 30, so that the user's selection of a link 110 takes the user to the closest (or least costly) mirror 18 of the selected content 15. The IP proximity resource allocation system 100 and method for localization of http links 50 therefore provides an effective method for directing users automatically to the preferred mirror 18.

Some embodiments of the IP proximity resource allocation system 100 and associated method 50 map out all IP address space, such as through a global routing table in BGP. As well, some preferred embodiments of the IP proximity resource allocation system 100 and associated method 50 perform triangulation and performance testing to all 150K networks in the Global routing table, such that system responds optimally to the client IP address 36.

Some preferred embodiments of the IP proximity resource allocation system 100 and associated method 50, such as available through America Online, Inc., provide localization decisions which take place invisibly to a client user, within an environment in which both the client application 34 and server application 106 are integrated to seamlessly provide hyperlinks 110 (FIG. 5) to localized content 15.

As well, some embodiments of the IP proximity resource allocation system 100 and associated method 50 provide localization for other web based applications, whereby web pages are customized with links 110 and content 15, in which the links 110 are based on the originating client IP address 36.

Although the IP proximity resource allocation system and methods of use are described herein in connection with personal computers, mobile devices, and other microprocessor-based devices, such as portable digital assistants or network enabled cell phones, the apparatus and techniques can be implemented for a wide variety of electronic devices and systems, or any combination thereof, as desired.

As well, while the IP proximity resource allocation system and methods of use are described herein in connection with interaction between a user terminal and one or more mirror sites across a network such as the Internet, the IP proximity resource allocation system and methods of use can be implemented for a wide variety of electronic devices and networks or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A process for providing a link to a preferred mirror instance within a plurality of mirror instances of a content store, comprising the steps of:
determining localization information for each mirrored instance of the content store to each network from which users connect;
storing the localization information;
receiving a request from a user that includes a link to mirrored content;
querying the localization database to determine a preferred mirror to the user, based upon the stored localization information;
dynamically generating a localized link to the preferred mirror; and
transmitting the localized link to the user.

2. The process of claim 1, further comprising the step of:
automatically directing the user to the local mirror instance when the user selects the link.

3. The process of claim 1, wherein the localization information comprises a determined number of hops for each mirrored instance of the content store to each network from which users connect.

4. The process of claim 1, wherein the localization information comprises a latency for each mirrored instance of the content store to each network from which users connect.

5. The process of claim 1, wherein the localization information comprises a transmission cost for each mirrored instance of the content store to each network from which users connect.

6. The process of claim 1, wherein the localization information comprises mirror server load information.

7. The process of claim 1, wherein the localization information comprises mirror server operation information.

8. The process of claim 1, wherein the localization information comprises cost information.

9. The process of claim 1, wherein the localization information comprises network segment information.

10. The process of claim 1, wherein the localization information is stored in a database.

11. The process of claim 1, wherein the localization information is stored at a web service.

12. The process of claim 1, wherein the request comprises a web page.

13. The process of claim 1, wherein the localized link is included within a webpage, and wherein the webpage is transmitted to the user.

14. The process of claim 1, wherein the preferred mirror is determined from the request IP address of the user.

15. The process of claim 1, wherein the preferred mirror is determined from the request IP network of the user.

16. The process of claim 1, wherein the localized link comprises an HTTP link.

17. A process for providing a link to a preferred mirror instance within a plurality of mirror instances of a content store, comprising the steps of:
determining localization information for each mirrored instance of the content store to each network from which users connect;
storing the localization information;
receiving a request from a user terminal comprising a unique address that includes a link to the content store;
querying the localization database to determine a preferred mirror to the user, based upon the stored localization information and the unique address;
dynamically generating a localized link to the preferred mirror; and
transmitting the localized link to the user.

18. The process of claim 17, further comprising the step of:
automatically directing the user to the preferred mirror when the user selects the localized link.

19. The process of claim 17, wherein the localization information comprises a determined number of hops for each mirrored instance of the content store to each network from which users connect.

20. The process of claim 17, wherein the localization information comprises a latency for each mirrored instance of the content store to each network from which users connect.

21. The process of claim 17, wherein the localization information comprises a transmission cost for each mirrored instance of the content store to each network from which users connect.

22. The process of claim 17, wherein the localization information comprises mirror server load information.

23. The process of claim 17, wherein the localization information comprises mirror server operation information.

24. The process of claim 17, wherein the localization information comprises cost information.

25. The process of claim 17, wherein the localization information comprises network segment information.

26. The process of claim 17, wherein the localization information is stored in a database.

27. The process of claim 17, wherein the localization information is stored at a web service.

28. The process of claim 17, wherein the request comprises a web page.

29. The process of claim 17, wherein the localized link is included within a webpage, and wherein the webpage is transmitted to the user.

30. The process of claim 17, wherein the preferred mirror is further determined from a request IP network of the user.

31. A proximity resource allocation system for providing a link from any network within a plurality of networks from which a user terminal connect to a preferred mirror within a plurality of mirrors comprising a content store, comprising:
a localization database comprising localization information for each mirror of the content store to each of the networks; and
a network service provider for receiving a request from a user terminal comprising a unique address that includes a link to the content store, for determining a preferred mirror to the user terminal, based upon the stored localization information and the unique address, for dynamically generating a localized link to the preferred mirror, and for transmitting the localized link to the user.

32. The system of claim 31, further comprising:
means to direct the user terminal to the preferred mirror upon a selection of the localized link.

33. The system of claim 31, wherein the localization information comprises a determined number of hops from each mirror to each of the networks.

34. The system of claim 31, wherein the localization information comprises a latency for each mirror of the content store to each of the networks.

35. The system of claim 31, wherein the unique address comprises a terminal IP address.

36. The system of claim 31, wherein the localization information comprises mirror server load information.

37. The system of claim 31, wherein the localization information comprises mirror server operation status information.

38. The system of claim 31, wherein the localization information comprises cost information.

39. The system of claim 31, wherein the localization information comprises network segment information.

40. The system of claim 31, wherein the localization information comprises a map of IP address space within a global routing table.

41. The system of claim 31, wherein the localization information comprises triangulation tests and performance tests of the networks.

42. The system of claim 31, wherein the request comprises a web page.

43. The system of claim 31, wherein the localized link is included within a webpage, and wherein the webpage is transmitted to the user.
